(19) United States
(12) Patent Application Publication
(10) Pub. No.: US 2016/0110501 A1
(43) Pub. Date: Apr. 21, 2016

(54) Natural Language Processing Correction Based on Treatment Plan

(71) Applicant: International Business Machines Corporation, Armonk, NY (US)

(72) Inventors: Corville O. Allen, Morrisville, NC (US); Elizabeth T. Dettman, Rochester, MN (US); Andrew R. Freed, Cary, NC (US); Michael T. Payne, Rochester, MN (US); Michael W. Schroeder, Rochester, MN (US)

(21) Appl. No.: 14/514,563

(22) Filed: Oct. 15, 2014

(51) Int. Cl. G06F 19/00

(52) U.S. Cl. CPC G06F 19/322

(57) ABSTRACT

An approach is provided in which an information handling system extracts treatment segments from documents corresponding to a patient and uses cognitive analysis to identify common treatment properties of a subset of the treatment segments. The information handling system combines the subset of treatment segments into a treatment aggregation that corresponds to a treatment history of the patient. In turn, the information handling system ingests the treatment aggregation into a domain for subsequent processing.

### BACKGROUND

Many sources generate clinical notes to document a patient's care. The sources may include, for example, doctors, nurses, in-house assistants, lab results providers, computer-generated notes, etc. As such, the format and information included in the clinical notes varies based upon the preferences of the different sources. For example, a first note might state that a patient was on “protocol A”, a second note might state that a patient was on “drug B”, a third note may state that “the patient was on Treatment X starting July 2014”.

Over time, a patient's care may generate a numerous amount of clinical notes, which may have complex interdependencies, duplications of information, or omissions of information. For example, one doctor's “protocol A” may be the same treatment as a different doctor's “Treatment X,” and both may include drugs B, C, and D. As such, the patient's clinical notes may be more confusing than helpful to a caregiver, especially a caregiver that is new to providing care to the patient.

### BRIEF SUMMARY

According to one embodiment of the present disclosure, an approach is provided in which an information handling system extracts treatment segments from documents corresponding to a patient and uses cognitive analysis to identify common treatment properties of a subset of the treatment segments. The information handling system combines the subset of treatment segments into a treatment aggregation that corresponds to a treatment history of the patient. In turn, the information handling system ingests the treatment aggregation into a domain for subsequent processing.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts a schematic diagram of one illustrative embodiment of a knowledge manager system in a computer network;

FIG. 2 illustrates an information handling system, more particularly, a processor and common components, which is a simplified example of a computer system capable of performing the computing operations described herein;

FIG. 3 is an exemplary diagram depicting a knowledge manager system that uses cognitive analysis to correct patient data while ingesting patient documents;

FIG. 4 is an exemplary diagram depicting a corpus of documents corresponding to a patient's treatment history;

FIG. 5 is an exemplary diagram depicting an intelligent interpreter generating treatment aggregations from treatment segments based upon cognitive relationship entries;

FIG. 6 is an exemplary diagram depicting a patient's treatment history on a chronological graph;

FIG. 7 is an exemplary flowchart depicting steps by a knowledge manager system to aggregate treatments based upon cognitive relationship entries; and

FIG. 8 is an exemplary flowchart depicting steps by knowledge manager system to compare treatment aggregations against clinical guidelines to verify estimated treatment end dates and overall treatment times.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

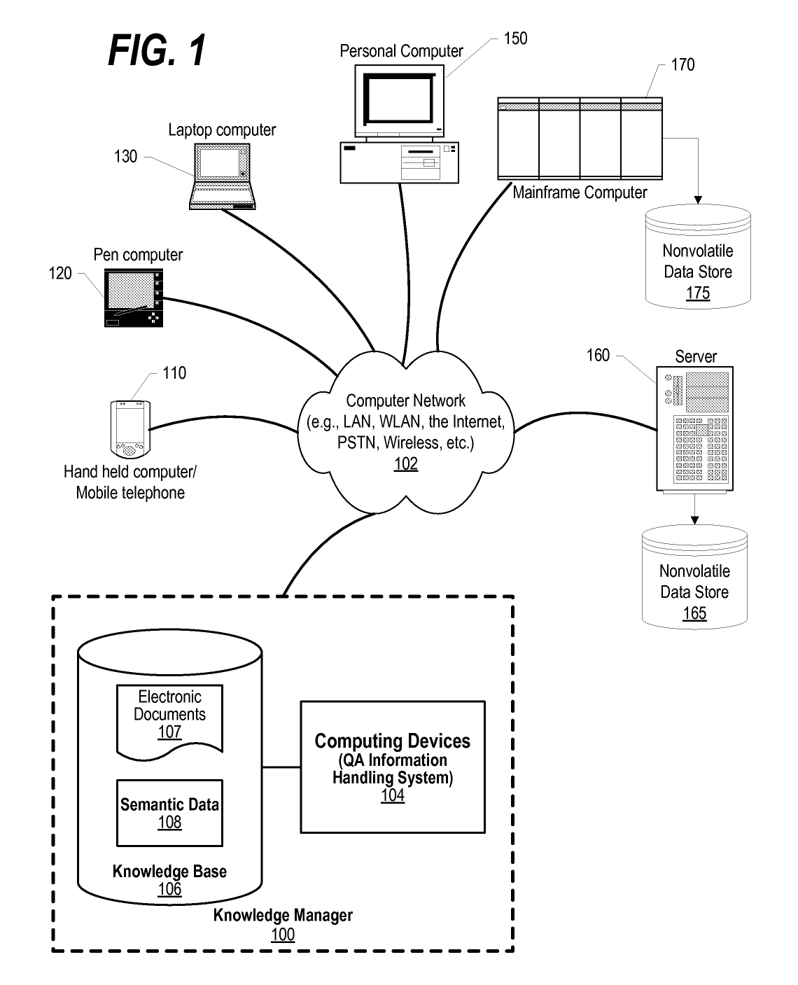

FIG. 1 depicts a schematic diagram of one illustrative embodiment of a question/answer creation (QA) system 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 106 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 100. The document 106 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

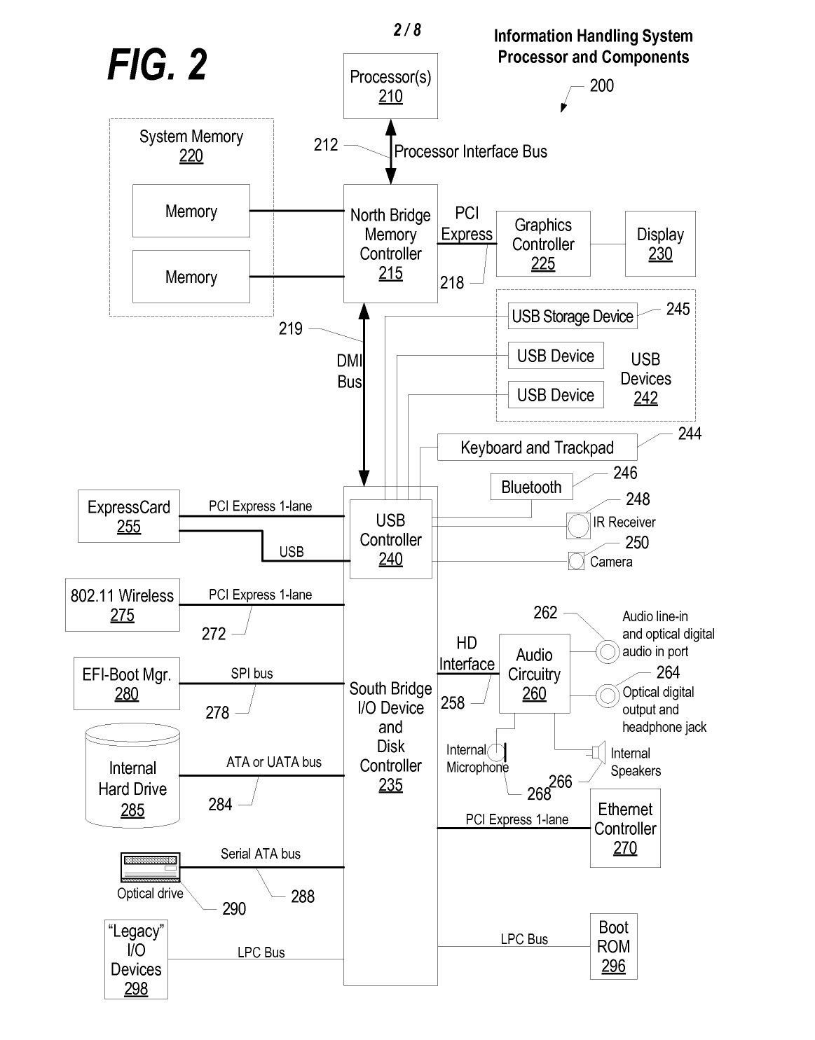

Types of information handling systems that can utilize knowledge manager 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

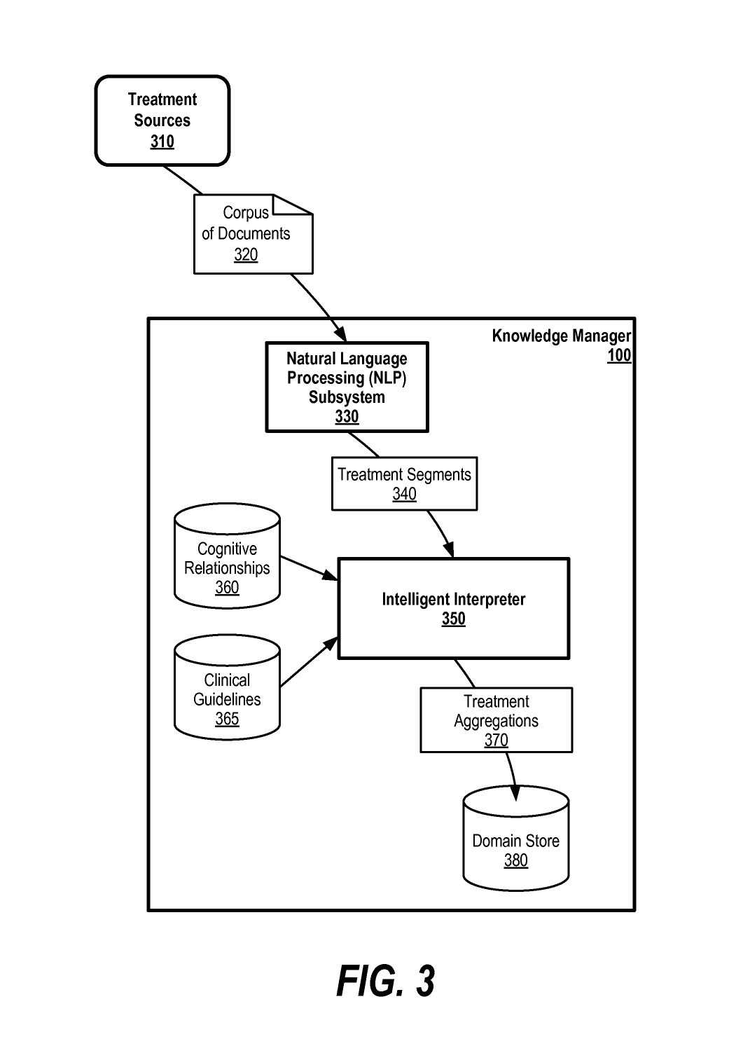

FIGS. 3-8 depict an approach that can be executed on an information handling system, which processes patient documents using a holistic approach to remove duplications of patient information and uncover missing treatment information. A knowledge manager system uses cognitive relationship entries to identify a subset of treatment segments that have common treatment properties. The knowledge manager system aggregates the subset of treatment segments into a treatment aggregation that, in one embodiment, the knowledge manager system displays on a chronological graph. In another embodiment, the knowledge manager system generates an estimated treatment end date for a first treatment based upon a mutually exclusive second treatment's start date. In yet another embodiment, the knowledge manager system verifies estimated treatment end dates by comparing a treatment's overall treatment time with clinical guidelines.

FIG. 3 is an exemplary diagram depicting a knowledge manager system that uses cognitive analysis to correct patient data while ingesting patient documents. Knowledge manager 100 analyzes patient data during document ingestion to remove treatment note duplications and correct issues that arise during ingestion. Knowledge manager 100 receives corpus of documents 320 (patient documents) form treatment sources 310. Treatment sources 310 may include patient data from multiple doctors, multiple hospitals, multiple labs, or other source that document some type of treatment or care to a particular patient.

Knowledge manager 100 includes natural language processing (NLP) subsystem 330, which parses the patient documents into treatment segments 340. In one embodiment, a treatment segment is one or more sentences, a phrase, term or n-gram that includes data related to information about a treatment. For example, a note might indicate that a patient was on “treatment X” and another note might indicate that a patient was on “drug B”, and a third note may indicate, “The patient was on protocol X starting July 2014”. In this example, NLP subsystem 330 generates a treatment segment for each of the notes.

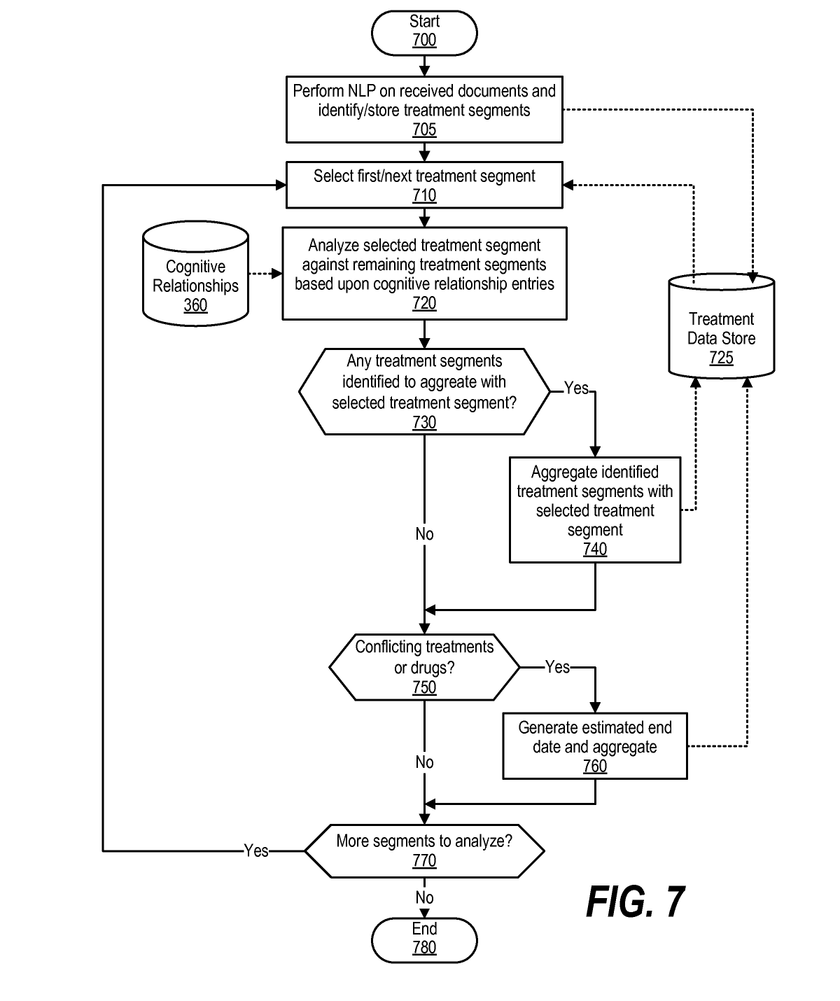

Intelligent interpreter 350 analyzes treatment segments 340 at a holistic level using cognitive relationship entries stored in cognitive relationships 360 to generate treatment aggregations 370 that combine treatment segment duplications and similar treatments (see FIG. 7 and corresponding text for further details). For example, treatment intelligent interpreter 350 may identify a cognitive relationship entry that indicates all three of the above notes correspond to one treatment aggregation.

In one embodiment, intelligent interpreter 350 identifies mutually exclusive treatments and generates an estimated treatment end date based upon the mutually exclusive treatment start date. For example, a patient may be on treatment X and start treatment Y, but a cognitive relationship entry may indicate that treatment X cannot occur at the same time as treatment Y. In this example, intelligent interpreter 350 identifies treatment Y's start date and generates an estimated treatment end date for treatment X. In another embodiment, intelligent interpreter 350 uses clinical guidelines stored in clinical guidelines 365 to verify treatment times of treatment aggregations having an estimated treatment end date. Continuing with the example above, intelligent interpreter 350 may determine that the treatment time for treatment X is six months and compares the six month treatment time against clinical guidelines of treatment X's typically treatment time (e.g., three to nine months).

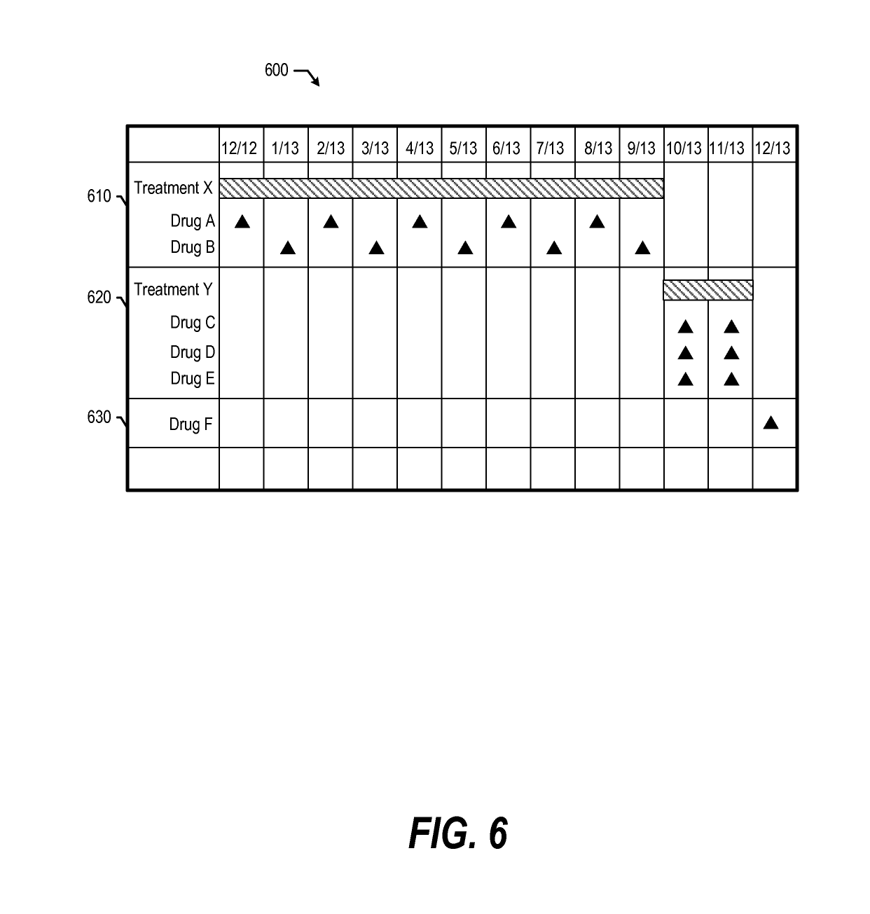

Knowledge manager 100 ingests treatment aggregations 370 into a domain located in domain store 380 for subsequent use, such as to generate a chronological graph of a patient's treatment history (see FIG. 6 and corresponding text for further details). In one embodiment, knowledge manager 100 may generate a chronological graph that includes chronological compositions of the treatment aggregations. The chronological graph provides a doctor and patient a graphical view of the patient's treatment history (see FIG. 6 and corresponding text for further details).

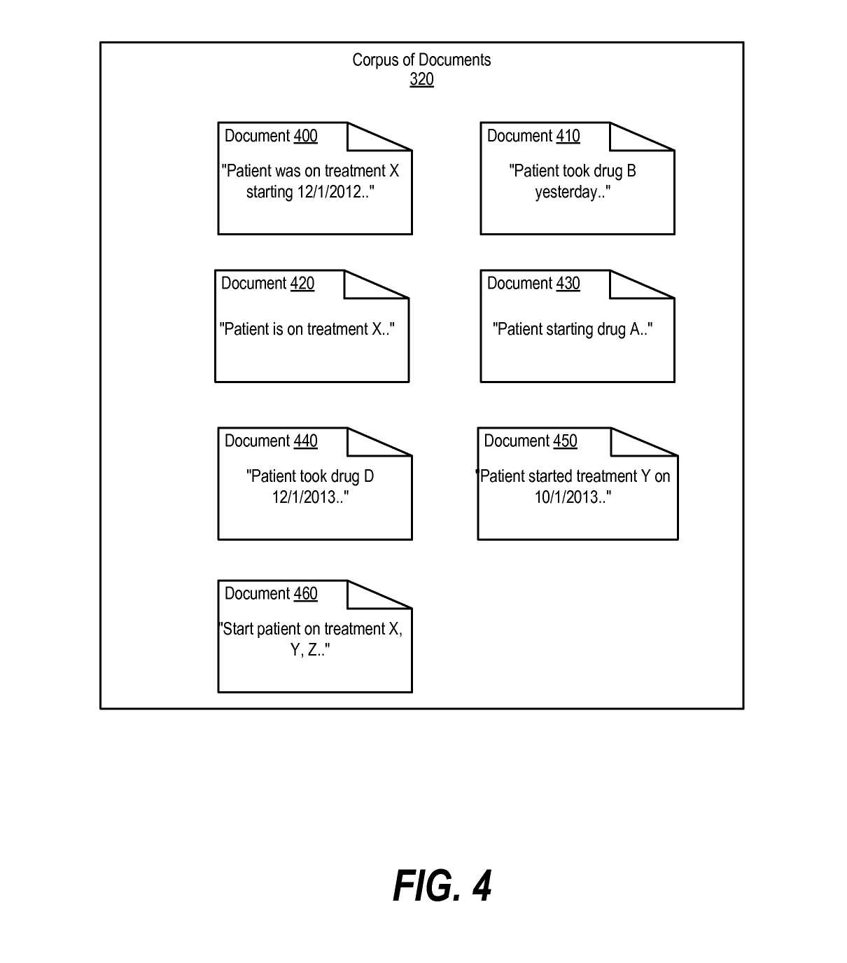

FIG. 4 is an exemplary diagram depicting a corpus of documents corresponding to a patient's treatment history. Corpus of documents 320 may include a substantial amount of patient data with complex interdependences generated from structured sources and unstructured sources such as doctors, nurses, in-house care givers, lab results, etc.

Document 400 shows that the patient started treatment X on Dec. 1, 2012. Treatment X may include several drugs, such as drug A, B, C, etc., which a doctor administers at different times. Knowledge manager 100 manages these nuances based upon the cognitive relationship entries stored in cognitive relationships 360 (see FIG. 7 and corresponding text for further details).

Document 410 indicates that the patient took drug B “yesterday”. In one embodiment, NLP subsystem 330 may identify the date at which document 410 was written and compute an actual administration date of drug B, which NLP subsystem 330 stores in a corresponding treatment segment. Document 420 indicates that patient is on treatment X and, based on the date that a doctor wrote document 420, document 420 may be a duplication of document 400.

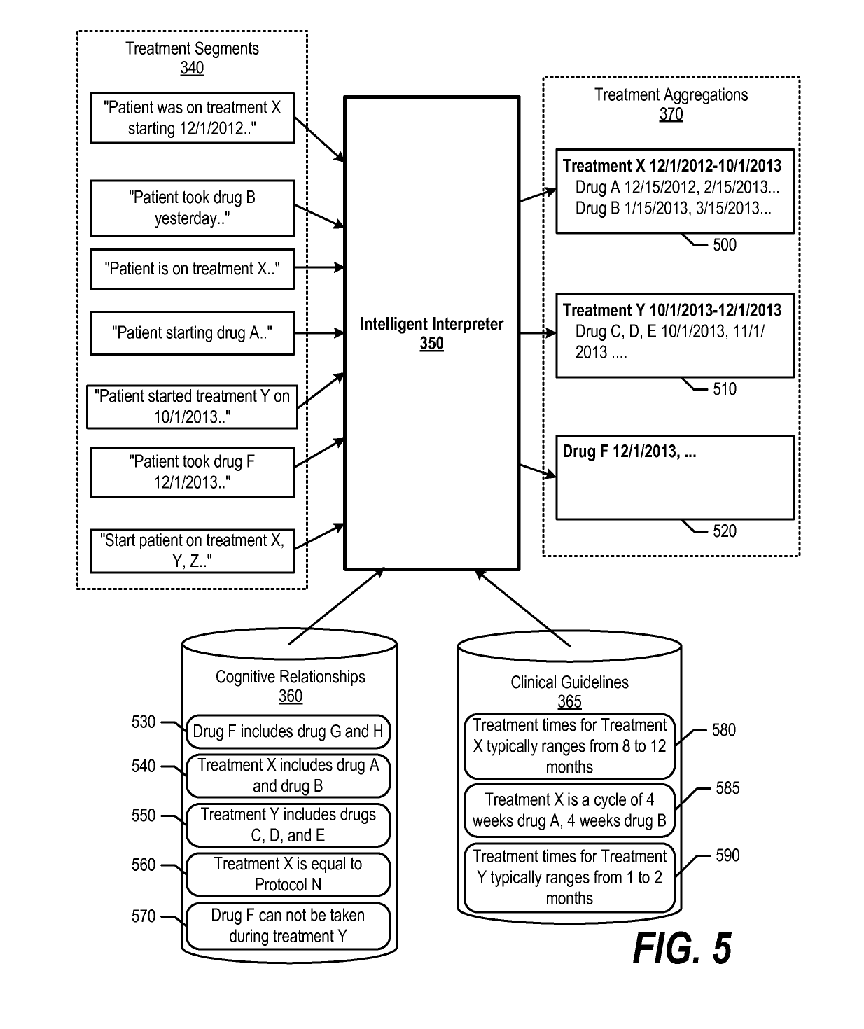

Document 430 indicates that the patient is starting drug A. Intelligent interpreter 350 uses the cognitive relationship entries to determine whether drug A is part of treatment X, whether drug A is mutually exclusive to treatment X, or whether drug A is independent of treatment X. Likewise, intelligent interpreter 350 performs the same analysis to documents 440, 450, and 460 to determine dependences between the treatment segments generated from the patient documents (see FIG. 5 and corresponding text for further details).

FIG. 5 is an exemplary diagram depicting an intelligent interpreter generating treatment aggregations from treatment segments based upon cognitive relationship entries. Intelligent interpreter 350 receives treatment segments 340 from NLP subsystem 330 and uses cognitive relationship entries 330-370 to interpret treatment segments 340 from a holistic viewpoint.

Intelligent interpreter 350 generates treatment aggregation 500 from treatment segments 340 based upon cognitive relationship entry 540, which indicates that treatment X includes drug A and drug B. Intelligent interpreter 350 generates treatment aggregation 510 from treatment segments 340 based upon cognitive relationship entry 550, which indicates that treatment Y includes drugs C, D, and E. In addition, intelligent interpreter 350 generates treatment aggregation 520 from treatment segments 340 based upon cognitive relationship entry 570, which indicates that drug F is mutually exclusive to treatment Y. In addition, cognitive relationship entry 570 provides insight as to when treatment Y ends based on when drug F begins and, therefore, intelligent interpreter 350 may generate an estimated treatment end date for treatment Y based upon drug F's start date. Intelligent interpreter 350, in turn, adds the estimated treatment end date to treatment aggregation 510.

In one embodiment, intelligent interpreter 350 checks the estimated treatment end dates by comparing a treatment's overall time against clinical guidelines 580-590 included in clinical guidelines 365. For example, treatment Y's estimated end date may indicate that the patient was on treatment Y for two months. In this example, intelligent interpreter 350 compares the two-month treatment time against clinical guideline 590 and determines that the estimated end date is correct.

FIG. 6 is an exemplary diagram depicting a patient's treatment history on a chronological graph. Chronological graph 600 shows a patient's treatments and drugs administered between December 2012 and December 2013. In one embodiment, knowledge manager 100 generates a chronological composition of a treatment aggregation so a doctor or patient can easily understand the patient's treatment history. Chronological composition 610 corresponds to treatment aggregation 500 shown in FIG. 5. Chronological composition 610 shows that treatment X includes drug A and drug B, which a caregiver administers to the patient on alternating months.

Similarly, chronological composition 620 corresponds to treatment aggregation 510 and shows that treatment Y commenced after treatment X and includes drugs C, D, and E, which were each administered on a monthly basis. Chronological composition 630 corresponds to treatment aggregation 520 that corresponds to drug F, which intelligent interpreter 350 may generate from a single treatment segment.

FIG. 7 is an exemplary flowchart depicting steps by a knowledge manager system to aggregate treatments based upon cognitive relationship entries. Processing commences at 700, whereupon the process performs natural language processing (NLP) on patient documents to identify treatment segments and store the treatment segments in treatment data store 725 (step 705). At step 710, the process selects the first treatment segment and, at step 720, the process analyzes the selected treatment segment against the other treatment segments in treatment data store 725 based upon cognitive relationship entries included in cognitive relationships 360. For example, if the selected treatment segment pertains to “drug D,” the process identifies cognitive relationship entries pertaining to drug D and analyzes the other treatment segments based upon the cognitive relationship entries (e.g., drug D is equivalent to drug G).

The process determines, based upon the analysis in step 720, as to whether treatment data store 725 includes treatment segments to aggregate with the selected treatment segment (decision 730). For example, the process may identify four treatment segments that indicate a patient was administered “drug B” and different times. If the process identifies treatment segments to aggregate, then decision 730 branches to the ‘yes’ branch whereupon, at step 740, the process aggregates the selected treatment segment with the identified treatment segments into a treatment aggregation.

On the other hand, if the process does not identify treatment segments to aggregate with the selected treatment segment, then decision 730 branches to the ‘no’ branch bypassing treatment aggregation step 740.

The process determines, based upon the analysis in step 720, as to whether treatment data store 725 includes treatment segments that are conflicting, or mutually exclusive treatments or drugs relative to the selected treatment segment (decision 750). For example, the selected treatment segment may correspond to treatment X and a cognitive relationship entry may state that a patient should not take drug F when the patient is on treatment X. In this example, the process may locate a treatment segment in treatment data store 725 that indicates the patient was administered drug F at a particular date.

If the process identifies conflicting treatments or drugs, then decision 750 branches to the ‘yes’ branch whereupon, at step 760, the process identifies a start date of the conflicting treatment and generates an estimated treatment end data for the selected treatment segment/aggregation. On the other hand, if the process does not identify conflicting treatments or drugs, then decision 750 branches to the ‘no’ branch.

The process determines as to whether treatment data store 725 includes more treatment segments to analyze (decision 770). If treatment data store 725 includes more treatment segments to analyze, then decision 770 branches to the ‘yes’ branch which loops back to select and process the next treatment segment. On the other hand, if treatment data store 725 does not include more treatment segments to analyze, then decision 770 branches to the ‘no’ branch. FIG. 7 processing thereafter ends at 780.

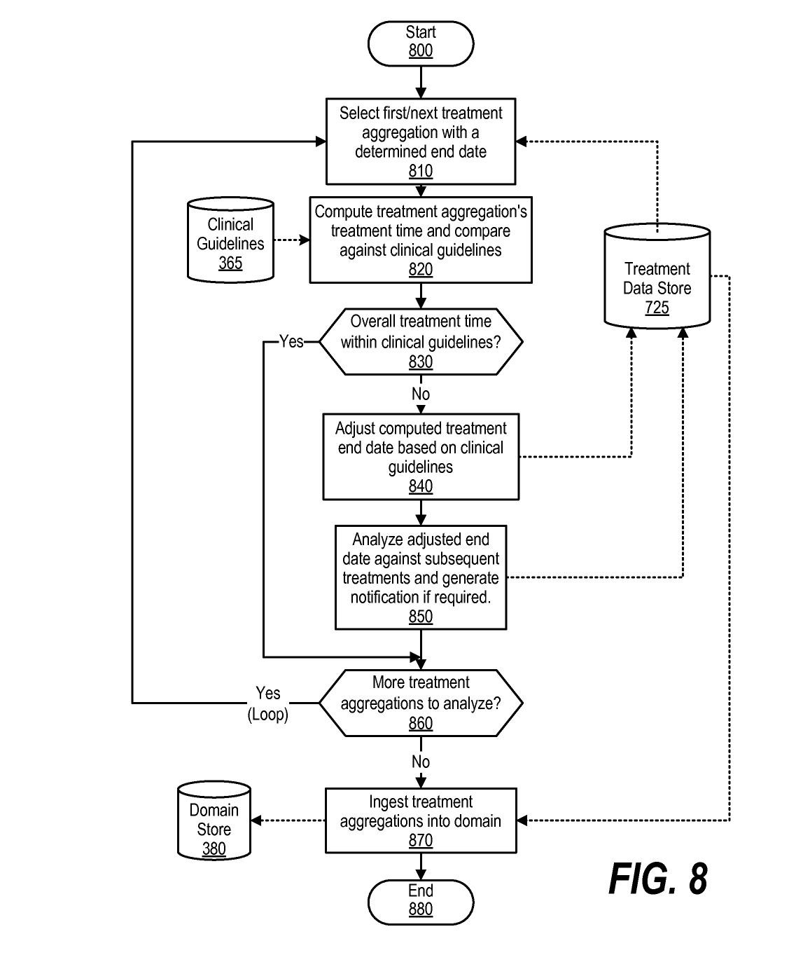

FIG. 8 is an exemplary flowchart depicting steps by a knowledge manager system to compare treatment aggregations against clinical guidelines to verify estimated treatment end dates and overall treatment times. Processing commences at 800, whereupon, at step 810, the process selects a first treatment aggregation with an estimated treatment end date based upon a conflicting treatment segment (see FIG. 7 and corresponding text for further details). The embodiment shown in FIG. 8 assumes that treatment segments and treatment aggregations that do not have estimated treatment end dates adhere to the clinical guidelines. In another embodiment, the process may analyze each treatment aggregation and individual treatment segment regardless of whether the treatment aggregation includes a noted treatment end date or an estimated end date.

At step 820, the process computes the treatment aggregation's overall treatment time using the treatment start date and estimated treatment end date, and compares the treatment time against clinical guidelines. For example, a treatment aggregation may have a treatment start date of Jan. 1, 2012 and an estimated treatment end date of Jun. 30, 2012, resulting in a treatment time of six months. The process compares the six-month treatment time against clinical guidelines of treatment X to determine whether the estimated treatment end date is valid.

The process determines as to whether the overall treatment time is within clinical guidelines (decision 830). If the overall treatment time is within the clinical guidelines, then decision 830 branches to the ‘yes’ branch. On the other hand, if the treatment time is not within the clinical guidelines, then decision 830 branches to the ‘no’ branch. At step 840, the process adjusts the estimated treatment end date based upon the clinical guidelines. Using the example above, if treatment X's clinical guidelines indicate a treatment time between three to five months, the process may change the estimated treatment end date to May 31, 2012 because the patient may have stopped treatment X one month prior to starting the conflicting treatment.

At step 850, the process analyzes the adjusted treatment end date against subsequent treatments and generates a notification if required. For example, if the adjusted treatment end date causes conflicts with other treatments or clinical guidelines, the process generates a notification because the patient may have had adverse reactions to the treatment or combination of treatments.

The process determines as to whether treatment data store 725 includes more treatment aggregations to analyze (decision 860). If treatment data store 725 includes more treatment aggregations to analyze, then decision 860 branches to the ‘yes’ branch. On the other hand, if treatment data store 725 includes does not include more treatment aggregations to analyze, then decision 860 branches to the ‘no’ branch. At step 870, the process ingests the treatment aggregations into domain store 380, which the process subsequently utilizes to answer questions pertaining to the corresponding patient. In one embodiment, the process generates a chronological graph that includes the chronological compositions of the treatment aggregations, such as that shown in FIG. 6. FIG. 8 processing thereafter ends at 880.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
extracting, by the processor, a plurality of treatment segments from a plurality of documents corresponding to a patient;
identifying one or more common treatment properties based upon cognitive analysis of the plurality of treatment segments, wherein the one or more common treatment properties correspond to a subset of the plurality of treatment segments;
combining the subset of treatment segments into a treatment aggregation, wherein the treatment aggregation corresponds to a treatment history of the patient; and
ingesting the treatment aggregation into the information handling system.

2. The method of claim 1 wherein the cognitive analysis further comprises:
evaluating one or more cognitive relationship entries, wherein a first one of the one or more cognitive relationship entries associates a first drug to a second drug;
determining that a first one of the plurality of treatment segments comprises the first drug and determining that a second one of the plurality of treatment segments comprises the second drug; and
including the first treatment segment and the second treatment segment into the subset of treatment segments based upon the first cognitive relationship entry.

3. The method of claim 1 wherein the treatment aggregation corresponds to a chronological treatment history of the patient, the method further comprising:
generating a chronological composition of the treatment aggregation, wherein the chronological composition comprises a treatment timeline indicator corresponding to the chronological treatment history, one or more first drug indicators corresponding to the first drug, and one or more second drug indicators corresponding to the second drug; and
adding the chronological composition to a chronological graph.

4. The method of claim 1 further comprising:
determining that a selected one of the plurality of treatment segments is mutually exclusive to the treatment aggregation based upon one or more cognitive relationship entries, wherein the selected treatment segment includes a first start date;
determining an estimated treatment end date of the treatment aggregation based upon the first start date; and
adding the estimated treatment end date to the treatment aggregation.

5. The method of claim 4 wherein the treatment aggregation comprises a second start date based upon one of the subset of treatment segments, the method further comprising:
determining a treatment time of the treatment aggregation based upon the second start date and the estimated treatment end date;
comparing the treatment time to one or more clinical guidelines that correspond to the treatment aggregation;
adjusting the estimated treatment end date based upon the comparison; and
generating a notification in response to the adjusting of the estimated treatment end date.

6. The method of claim 1 wherein the plurality of documents are written in a natural language context, the method further comprising:
parsing a selected one of the plurality of documents into a plurality of sentence parts; and
deriving a corresponding one of the plurality of treatment segments based upon natural language processing analysis of the plurality of sentence parts.

7. The method of claim 1 further comprising:
determining that a first one of the plurality of treatment segments comprises a first drug and determining that a second one of the plurality of treatment segments comprises the first drug; and
removing the second treatment segment from the plurality of treatment segments.

8. The method of claim 1 wherein the treatment segment comprises data corresponding to a treatment administered to the patient, and wherein the treatment segment is selected from the group consisting of one or more sentences, a phrase, a term, and an n-gram.

9. An information handling system comprising:
one or more processors;
a memory coupled to at least one of the processors; and
a set of computer program instructions stored in the memory and executed by at least one of the processors in order to perform actions of:
extracting a plurality of treatment segments from a plurality of documents corresponding to a patient;
identifying one or more common treatment properties based upon cognitive analysis of the plurality of treatment segments, wherein the one or more common treatment properties correspond to a subset of the plurality of treatment segments;
combining the subset of treatment segments into a treatment aggregation, wherein the treatment aggregation corresponds to a treatment history of the patient; and
ingesting the treatment aggregation into the information handling system.

10. The information handling system of claim 9 wherein the one or more processors perform additional actions comprising:
evaluating one or more cognitive relationship entries, wherein a first one of the one or more cognitive relationship entries associates a first drug to a second drug;
determining that a first one of the plurality of treatment segments comprises the first drug and determining that a second one of the plurality of treatment segments comprises the second drug; and
including the first treatment segment and the second treatment segment into the subset of treatment segments based upon the first cognitive relationship entry.

11. The information handling system of claim 9 wherein the treatment aggregation corresponds to a chronological treatment history of the patient, and wherein the one or more processors perform additional actions comprising:
generating a chronological composition of the treatment aggregation, wherein the chronological composition comprises a treatment timeline indicator corresponding to the chronological treatment history, one or more first drug indicators corresponding to the first drug, and one or more second drug indicators corresponding to the second drug; and
adding the chronological composition to a chronological graph.

12. The information handling system of claim 9 wherein the one or more processors perform additional actions comprising:
determining that a selected one of the plurality of treatment segments is mutually exclusive to the treatment aggregation based upon one or more cognitive relationship entries, wherein the selected treatment segment includes a first start date;
determining an estimated treatment end date of the treatment aggregation based upon the first start date; and
adding the estimated treatment end date to the treatment aggregation.

13. The information handling system of claim 12 wherein the treatment aggregation comprises a second start date based upon one of the subset of treatment segments, and wherein the one or more processors perform additional actions comprising:
determining a treatment time of the treatment aggregation based upon the second start date and the estimated treatment end date;
comparing the treatment time to one or more clinical guidelines that correspond to the treatment aggregation;
adjusting the estimated treatment end date based upon the comparison; and
generating a notification in response to the adjusting of the estimated treatment end date.

14. The information handling system of claim 9 wherein the plurality of documents are written in a natural language context, and wherein the one or more processors perform additional actions comprising:
parsing a selected one of the plurality of documents into a plurality of sentence parts; and
deriving a corresponding one of the plurality of treatment segments based upon natural language processing analysis of the plurality of sentence parts.

15. The information handling system of claim 9 wherein the one or more processors perform additional actions comprising:
determining that a first one of the plurality of treatment segments comprises a first drug and determining that a second one of the plurality of treatment segments comprises the first drug; and
removing the second treatment segment from the plurality of treatment segments.

16. A computer program product stored in a computer readable storage medium, comprising computer program code that, when executed by an information handling system, causes the information handling system to perform actions comprising:
extracting a plurality of treatment segments from a plurality of documents corresponding to a patient;
identifying one or more common treatment properties based upon cognitive analysis of the plurality of treatment segments, wherein the one or more common treatment properties correspond to a subset of the plurality of treatment segments;
combining the subset of treatment segments into a treatment aggregation, wherein the treatment aggregation corresponds to a treatment history of the patient; and
ingesting the treatment aggregation into the information handling system.

17. The computer program product of claim 16 wherein the information handling system performs additional actions comprising:
evaluating one or more cognitive relationship entries, wherein a first one of the one or more cognitive relationship entries associates a first drug to a second drug;
determining that a first one of the plurality of treatment segments comprises the first drug and determining that a second one of the plurality of treatment segments comprises the second drug; and
including the first treatment segment and the second treatment segment into the subset of treatment segments based upon the first cognitive relationship entry.

18. The computer program product of claim 16 wherein the treatment aggregation corresponds to a chronological treatment history of the patient, and wherein the information handling system performs additional actions comprising:
generating a chronological composition of the treatment aggregation, wherein the chronological composition comprises a treatment timeline indicator corresponding to the chronological treatment history, one or more first drug indicators corresponding to the first drug, and one or more second drug indicators corresponding to the second drug; and
adding the chronological composition to a chronological graph.

19. The computer program product of claim 16 wherein the information handling system performs additional actions comprising:
determining that a selected one of the plurality of treatment segments is mutually exclusive to the treatment aggregation based upon one or more cognitive relationship entries, wherein the selected treatment segment includes a first start date;
determining an estimated treatment end date of the treatment aggregation based upon the first start date; and
adding the estimated treatment end date to the treatment aggregation.

20. The computer program product of claim 19 wherein the treatment aggregation comprises a second start date based upon one of the subset of treatment segments, and wherein the information handling system performs additional actions comprising:
determining a treatment time of the treatment aggregation based upon the second start date and the estimated treatment end date;
comparing the treatment time to one or more clinical guidelines that correspond to the treatment aggregation;
adjusting the estimated treatment end date based upon the comparison; and
generating a notification in response to the adjusting of the estimated treatment end date.
